(19) United States
(12) Patent Application Publication
(10) Pub. No.: US 2022/0372935 A1
(43) Pub. Date: Nov. 24, 2022

(54) SYSTEMS AND METHODS FOR A SMART HYDROGEN INJECTION CONTROLLER

(71) Applicant: NABORS ENERGY TRANSITION SOLUTIONS LLC, Houston, TX (US)

(72) Inventors: Evan JOHNSON, Spring, TX (US); Dylan COOK, Spring, TX (US); Paul YOLLIN, Spring, TX (US); Eli ADLER, Olympia, WA (US)

(21) Appl. No.: 17/664,077

(22) Filed: May 19, 2022

Related U.S. Application Data
(60) Provisional application No. 63/191,257, filed on May 20, 2021.

(51) Int. Cl. F02M 25/12; F02B 43/12

(52) U.S. Cl. CPC F02M 25/12; F02B 43/12

(57) ABSTRACT

Various embodiments of systems and methods for a smart hydrogen injection controller are disclosed herein. The system produces hydrogen and oxygen from a Proton Exchange Membrane (PEM) electrolyzer and injects these gases individually into a combustion engine using port injection or direct injection at each cylinder of the combustion engine. In one aspect, varying the ratio of hydrogen to oxygen works to improve the operation of the internal combustion engine to decrease emissions and increase combustion efficiency.

### CROSS-REFERENCE TO RELATED APPLICATION(S)

This application claims priority under 35 U.S.C. § 119(e) to U.S. Provisional Patent Application No. 63/191,257, entitled “SYSTEMS AND METHODS FOR A SMART HYDROGEN INJECTION CATALYST,” by Evan Johnson et al., filed May 20, 2021, which is assigned to the current assignee hereof and incorporated herein by reference in its entirety.

### FIELD OF THE DISCLOSURE

The present disclosure generally relates to a hydrogen injection controller, and in particular to a smart hydrogen injection controller that allows for isolated hydrogen and oxygen to be individually injected at a variable rate to force a more complete burn of the carbon based fuel.

### BACKGROUND

Over the last 40 years, many engineers have attempted to use hydrogen and hydrogen-oxygen to create a more complete combustion of carbon based fuels. The biggest issues involve the efficacy of producing hydrogen on demand, the precise control of the hydrogen injection, and the exorbitant costs associated with designing, building, and maintaining such a system.

It is with these observations in mind, among others, that various aspects of the present disclosure were conceived and developed.

### REFERENCE NUMBERS

100. Smart HIC
102. PEM Electrolyzer
104. Injection Controller
106. Injection Driver
108. Combustion Engine
110. User Interface
112. First Water Reservoir
114. Second Water Reservoir
116. Oxygen Supply Tank
118. Heat Exchanger
120. Hydrogen Supply Tank
122. Power Distribution
124. Connector
125. Filter
126. Water Supply Pump
127. Water and Oxygen Pump
128. Blow Off Valve
129. Release Valve
130. Pressure Sensor
131. Blow Off Valve
132. Water Pressure Sensor
133. Release Valve
134. Oxygen Pressure Sensor
135. One Way Valve
136. Thermometer
137. Production Relay
138. Amp Sensor
139. Voltage Regulator
140. Power Source— 12V Source
141. Ignition Source— 12V Ignition Source
142. Fan—Heat Exchanger
143. Plurality of Sensors
143A. NOx Sensor
143B. O2 Sensor
143C. Map Sensor
143D. Crank Sensor
143E. Cam Sensor
144. Plurality of Oxygen Injection Ports
145. Plurality of Hydrogen Injection Ports
146. Hydrogen Line Pressure Sensor
147. Oxygen Line Pressure Sensor

### BRIEF DESCRIPTION OF THE DRAWINGS

FIG. 1 is a schematic diagram showing the various components of the Smart HIC; and

FIG. 2 is a schematic diagram showing the operative connections between the Smart HIC and a combustion engine.

Corresponding reference characters indicate corresponding elements among the view of the drawings. The headings used in the figures do not limit the scope of the claims.

### DETAILED DESCRIPTION

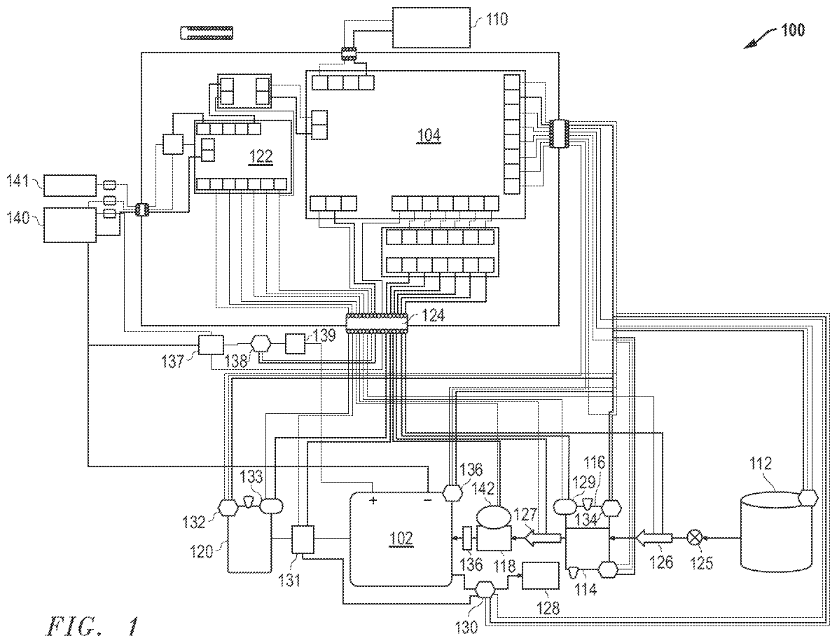

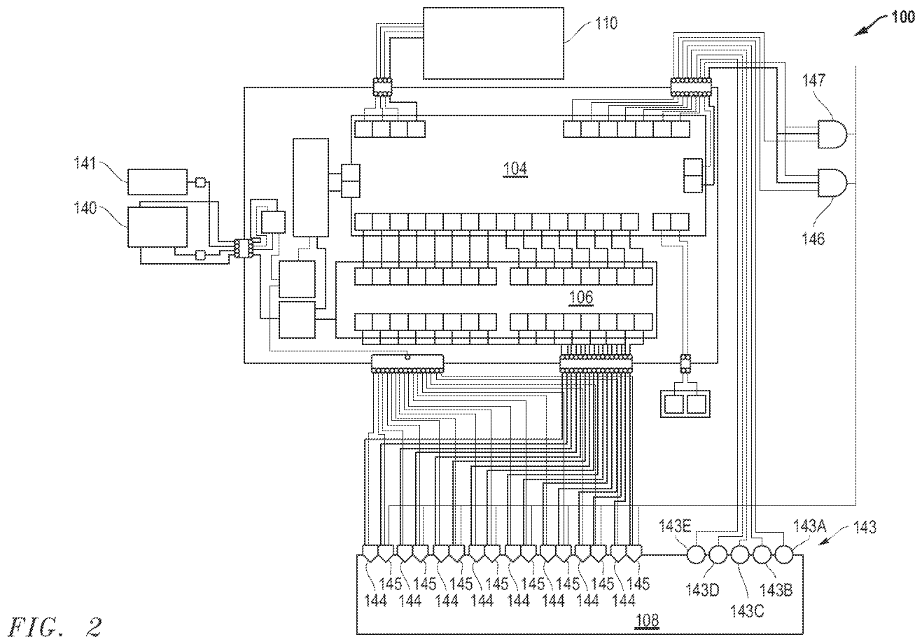

Various embodiments of systems and methods for a Smart Hydrogen injection controller (HIC) are disclosed herein. The Smart HIC system produces hydrogen and oxygen from a Proton Exchange Membrane (PEM) electrolyzer and injects these gases individually into a combustion engine using port injection or direct injection at each cylinder of the combustion engine. In one aspect, varying the ratio of hydrogen to oxygen works as a catalyst to improve the operation of an internal combustion engine to decrease emissions and increase combustion efficiency. Embodiments of the Smart HIC system are disclosed and generally indicated as 100 in FIGS. 1 and 2.

As shown in FIG. 1, the Smart HIC system 100 includes a PEM Electrolyzer 102 which allows for isolated hydrogen and oxygen to be individually injected at a variable rate in a combustion engine 108 that forces a more complete burn of the carbon-based fuel. Hydrogen has the ability to break down hydrocarbons, exciting the molecules and breaking down the fuel to carbon and energy that runs the combustion engine 108 to improve the operation of the internal combustion engine to allow greater efficiency and lower emission of undesired products.

Referring to FIG. 2, an injection controller 104 is in operative communication with an injection driver 106 that controls the injection of hydrogen through a plurality of hydrogen injectors 144 as well as the injection of oxygen through a plurality of oxygen injectors 145 in juxtaposition with the plurality of hydrogen injection ports 144 with respect to the combustion engine 108. In some embodiments, a hydrogen injectors 144 is paired with a respective oxygen injectors 145. As shown, a hydrogen line pressure sensor 146 is in communication with the hydrogen supply line and an oxygen line pressure sensor 147 is in communication with an oxygen supply line which transmits data to the injection controller 104. In some embodiments, the oxygen supply line may be made of a high PSI rubber designed to carry oxygen from the PEM electrolyzer 102 to the plurality of oxygen injectors 145. In some embodiments, the hydrogen supply line may be made of a high PSI rubber designed to carry hydrogen from the PEM electrolyzer 102 to the plurality of hydrogen injectors 144.

A user interface 110 is in operative communication with the injection controller 104 and is operable for displaying important information about the operation of the injectors 144 and 145. The user interface 110 may also be customized and users can request specific information. In some embodiments, a plurality of sensors 143 are in communication with the combustion engine 108 for detecting various metrics, for example, a NOx sensor 143A, an O₂ sensor 143B, a map sensor 143C, a crank sensor 143D, and a cam sensor 143E. In some embodiments, wires may be connected to CAN high and CAN low signals that will allow “sniffing” of operation data from the combustion engine 108.

Referring specifically to FIG. 1, a first water reservoir 112 supplies water through a water supply pump 126 to a second water reservoir 114 in communication with an oxygen supply tank 116 that pumps oxygen/water to a heat exchanger 118 before entering the PEM Electrolyzer 102 through a one way valve 131. In some embodiments, the heat exchanger 118 includes an exhaust fan 142. In some embodiments, the oxygen tank 116 includes a release valve 129 for releasing oxygen in an overpressure situation and an oxygen pressure sensor 134 for detecting the pressure within the oxygen tank 116.

As shown, a hydrogen supply line is in fluid flow communication with a hydrogen tank 120 for supplying hydrogen. In addition, a hydrogen pressure sensor 132 for detecting the pressure in the hydrogen tank 120 and a release valve 133 for releasing hydrogen in an overpressure situation.

In some embodiments, a 12V source 140 may provide power to the various components of the Smart HIC system 100 and is in operative communication with a power distribution 122. In addition, the Smart HIC system may include a 12V ignition source 141. The 12V source 140 may power a production relay 137.

In some embodiments, the injection controller 104 is in operative communication with an amp sensor 138 and a voltage regulator 139 through a connector 124.

In some embodiments, the PEM Electrolyzer 102 includes a thermometer 136 for detecting temperature. In some embodiments, a pressure sensor 130 is in communication with the PEM Electrolyzer 102 which detects pressure of the oxygen and water mixture and also communicates with a blowoff valve 128. A blowoff valve sensor 131 provides a pressure reading differential pressure with the pressure sensor 130.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A hydrogen injection controller system comprising: a proton exchange membrane (PEM) electrolyzer for producing hydrogen and oxygen; an injection controller in operative communication with the PEM electrolyzer; and a combustion engine having a plurality of hydrogen injectors and a plurality of oxygen injectors for individually injecting a hydrogen and oxygen into the combustion engine.

Embodiment 2. The hydrogen injection controller system of embodiment 1, wherein the injection controller is in operative communication with the injection controller for controlling the injection of hydrogen and oxygen into the combustion engine.

Embodiment 3. The hydrogen injection controller system of embodiment 1, wherein the injection controller is operable for varying the ratio of hydrogen and oxygen to generate a more complete burn of a carbon-based fuel in the combustion engine.

Embodiment 4. The hydrogen injection controller system of embodiment 1, wherein the plurality of hydrogen injectors and the plurality of oxygen injectors is either port or direct injection.

Embodiment 5. The hydrogen injection controller system of embodiment 1, further comprising: an user interface in operative communication with the injection controller for controlling the operation of the plurality of hydrogen injectors and the plurality of oxygen injectors.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A hydrogen injection controller system comprising:
a proton exchange membrane (PEM) electrolyzer for producing hydrogen and oxygen;
an injection controller in operative communication with the PEM electrolyzer; and
a combustion engine having a plurality of hydrogen injectors and a plurality of oxygen injectors for individually injecting a hydrogen and oxygen into the combustion engine.

2. The hydrogen injection controller system of claim 1, wherein the injection controller is in operative communication with the injection controller for controlling the injection of hydrogen and oxygen into the combustion engine.

3. The hydrogen injection controller system of claim 1, wherein the injection controller is operable for varying the ratio of hydrogen and oxygen to generate a more complete burn of a carbon-based fuel in the combustion engine.

4. The hydrogen injection controller system of claim 1, wherein the plurality of hydrogen injectors and the plurality of oxygen injectors is either port or direct injection.

5. The hydrogen injection controller system of claim 1, further comprising:
an user interface in operative communication with the injection controller for controlling the operation of the plurality of hydrogen injectors and the plurality of oxygen injectors.
